(19) United States
(12) Patent Application Publication
(10) Pub. No.: US 2009/0219369 A1
(43) Pub. Date: Sep. 3, 2009

(54) INK JET RECORDING APPARATUS

(75) Inventors: Masashi Hiroki, Yokohama-shi (JP); Takashi Kado, Izunokuni-shi (JP); Atsushi Kubota, Sunto-gun (JP); Satoshi Kaiho, Yokohama-shi (JP); Kazuhiko Ohtsu, Mishima-shi (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/390,551

(22) Filed: Feb. 23, 2009

Related U.S. Application Data
(60) Provisional application No. 61/032,366, filed on Feb. 28, 2008.
(60) Provisional application No. 61/040,899, filed on Mar. 31, 2008.

(51) Int. Cl. B41J 2/01

(52) U.S. Cl. 347/102

(57) ABSTRACT

An ink jet recording apparatus includes an ink jet head in which a plurality of nozzles are arranged, a sub-scan driving unit which carries a recording medium to be formed with an image, a first carrying unit which is disposed on a downstream side of a carrying direction of the recording medium by the sub-scan driving unit and carries the recording medium on which an image is formed by the ink jet head, and a second carrying unit which is disposed so as to face the first carrying unit and heats the recording medium interposed between the first carrying unit and the second carrying unit.

### CROSS-REFERENCE TO RELATED APPLICATION

This application claims the benefit of U.S. Provisional Application No. 61/032,366, filed Feb. 28, 2008, No. 61/040,899, filed Mar. 31, 2008.

### TECHNICAL FIELD

The present invention relates to an ink jet recording apparatus which ejects aqueous ink from an ink jet head to form an image on a paper.

### BACKGROUND

Recently, an ink jet recording apparatus in which an aqueous ink is used can form a high quality of image on a plain paper. Since running cost is low and the apparatus is safe and quiet, the ink jet recording apparatus becomes common practice for home or official use. The ink jet recording apparatus can record the image with high density at high speed. Further, the ink jet recording apparatus adopts a non-impact system, so that noises are little. Moreover, the ink jet recording apparatus has an advantage that a color image is easily recorded by using multicolored inks.

A paper to be recorded by the ink jet recording apparatus gets wet by the ink. When the ink jet recording apparatus performs a high quality recording on the paper, the paper is subjected to a heated-air drying.

On the paper, a phenomenon as referred to as a rippling cockling or a curl occurs due to moisture in ink. Especially, a cellulose fiber is likely to be swollen or untied in the plain paper.

In JP-A-10-217572, a configuration is disclosed in which the paper is heated from the rear surface thereof through a guide having a mesh structure, a distance between a heater and the paper is shorten, and heat of the heater is directly transferred to the paper. According to the configuration disclosed in JP-A-10-217572, since the vapor generated from the paper is removed through the mesh, a difference in dry condition between both sides of the paper disappears, and the curl can be reduced, so that a sufficient heating effect is exhibited.

Further, in JP-A-10-217572, a configuration is disclosed in which a heater which heats a recording area of the paper and a guide member having a mesh structure which diffuses vapor generated from the paper are provided on a carrying path after printing (mainly FIG. 5 and FIG. 6).

A printer having the configuration disclosed in JP-A-10-217572 exhibits a sufficient heating effect even though the heater does not come into contact with the paper over the entire surface. Further, in the printer, the vapor generated from the rear surface of the paper can be removed to the outside at any time. Moreover, in the printer, a difference in dry speed between both sides of the paper is decreased, and thus a bending of the paper can be substantially reduced. As a result, a carrying error which is generated in a transferring operation of the paper is not caused in the printer.

However, in the configuration described in JP-A-10-217572, since the paper is heated from the rear surface of the paper through the guide member having the mesh structure, efficiency in transferring the heat to the rear surface of the paper is low. Especially, in one-path high speed printing apparatus in which an ink jet head having the same width as the paper is used, it is difficult to sufficiently remove the moisture which is contained in the paper.

Further, in JP-A-10-217572, the heater does not come into sufficient contact with the paper upon being heated for drying, and it is difficult to efficiently transfer the heat generated from the heater to the paper.

An object of the present invention is to provide an ink jet recording apparatus, which can efficiently dry a paper on which an image is formed with ink.

### SUMMARY

According to one aspect of the present invention, there is provided an ink jet recording apparatus including: an ink jet head in which a plurality of nozzles are arranged; a sub-scan driving unit which carries a recording medium to be formed with an image; a first carrying unit which is disposed on a downstream side of a carrying direction of the recording medium by the sub-scan driving unit and carries the recording medium on which an image is formed by the ink jet head; and a second carrying unit which is disposed so as to face the first carrying unit and heats the recording medium interposed between the first carrying unit and the second carrying unit.

According to one aspect of the present invention, there is provided an ink jet recording apparatus including: an ink jet head in which a plurality of nozzles are arranged; a sub-scan driving unit which carries a recording medium to be formed with an image; a first roller which is disposed on a downstream side of a carrying direction of the recording medium by the sub-scan driving unit and carries the recording medium on which an image is formed by the ink jet head; and a second roller which is disposed so as to face the first roller and heats the recording medium.

According to one aspect of the present invention, there is provided a drying method using an ink jet recording apparatus which includes an ink jet head in which a plurality of nozzles are arranged, a sub-scan driving unit which carries a recording medium to be formed with an image, and a heat-fixing unit which is disposed on a downstream side of a carrying direction of the recording medium by the sub-scan driving unit and heats the recording medium on which an image is formed by the ink jet head, the method including: carrying the recording medium while interposing both surfaces of an image forming surface and an opposite surface to the image forming surface of the recording medium; and heating the recording medium from the opposite surface to the image forming surface.

### DESCRIPTION OF THE DRAWINGS

FIG. 1 is a cross-sectional view illustrating an ink jet recording apparatus viewed from a horizontal direction of a first embodiment.

FIG. 2 is a cross-sectional view illustrating a configuration of a heat-fixing device viewed from a horizontal direction of the first embodiment.

FIG. 3 is an external view of an upper carrying belt of the heat-fixing device of the first embodiment.

FIG. 4 is a cross-sectional view illustrating a guide viewed in a height direction of the heat-fixing device of the first embodiment.

FIG. 5 is a cross-sectional view illustrating a modified example of the heat-fixing device viewed from a horizontal direction of the first embodiment.

FIG. 6 is a cross-sectional view illustrating another modified example of the heat-fixing device viewed from a horizontal direction of the first embodiment.

FIG. 7 is a top perspective view schematically illustrating an appearance of an ink jet recording apparatus of a second embodiment.

FIG. 8 is a top perspective view illustrating a configuration of the heat-fixing device of the second embodiment.

FIG. 9 is a plan view illustrating a configuration of the heat-fixing device of the second embodiment.

FIG. 10 is a top perspective view illustrating a modified example of the heat-fixing device of the second embodiment.

FIG. 11 is a plan view illustrating a configuration of the heat-fixing device of the second embodiment shown in FIG. 10.

FIG. 12 is a top perspective view illustrating another modified example of the heat-fixing device of the second embodiment.

FIG. 13 is a plan view illustrating a configuration of the heat-fixing device of the second embodiment shown in FIG. 12.

FIG. 14 is a top perspective view illustrating another modified example of the heat-fixing device of the second embodiment.

FIG. 15 is a cross-sectional view illustrating another modified example of the heat-fixing device viewed from a horizontal direction of the second embodiment.

FIG. 16 is a block diagram illustrating a control system of the ink jet recording apparatus of the first embodiment.

### DETAILED DESCRIPTION

Hereinafter, embodiments will be described.

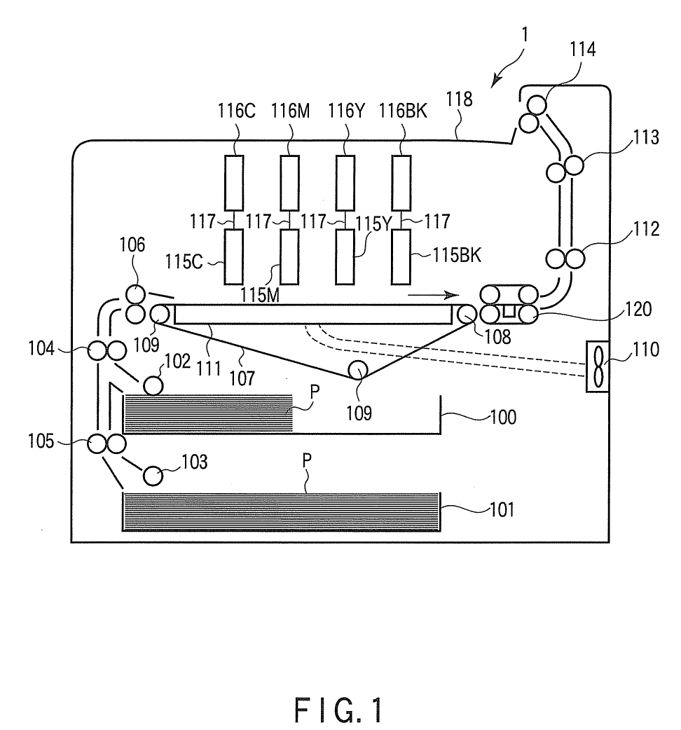

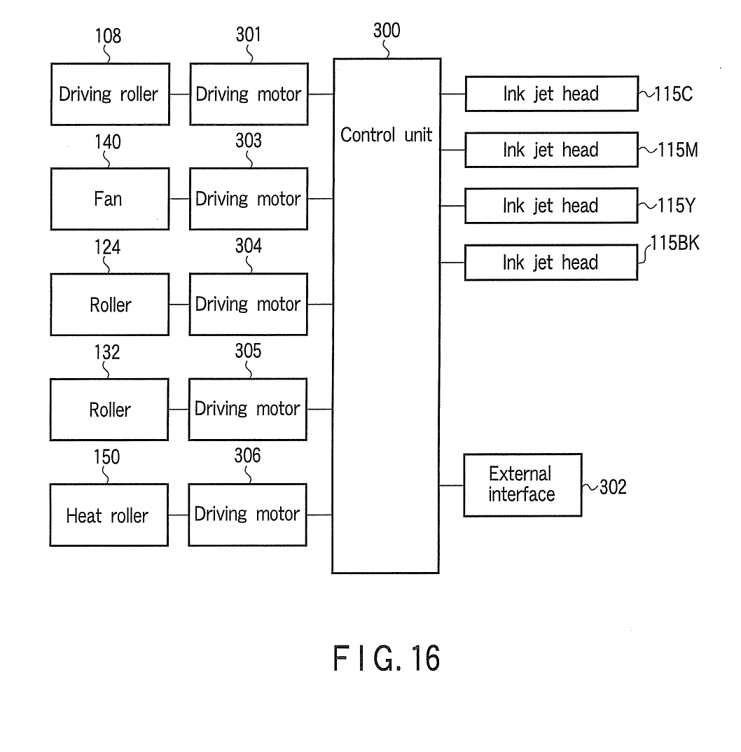

FIG. 1 is a cross-sectional view illustrating an ink jet recording apparatus 1 viewed from a horizontal direction of a first embodiment. FIG. 16 is a block diagram illustrating a control system of the ink jet recording apparatus 1 of the first embodiment.

A first paper cassette 100 and a second paper cassette 101 contain the recording mediums p which are different in size, respectively. A first paper feeding roller 102 withdraws the recording medium p corresponding to a selected size of the recording medium from the first paper cassette 100 to be carried to a pair of first carrying rollers 104 and a pair of resist rollers 106. Similarly, a second paper feeding roller 103 withdraws the recording medium p corresponding to a selected size of the recording medium from the second paper cassette 101 to be carried to a pair of second carrying rollers 105 and the pair of resist rollers 106.

A carrying belt 107 is applied with tension by a driving roller 108 and two driven rollers 109. In a surface of the carrying belt 107, holes are made at a predetermined interval. In addition, in the inside of the carrying belt 107, a negative pressure chamber 111 is provided so as to be connected to a fan 110 in order to absorb the recording medium p to the carrying belt 107. The driving roller 108 drives the carrying belt 107 so as to carry the recording medium p from an upstream side on which the pair of the resist rollers 106 are formed as a paper feeding unit to a downstream side on which a pair of first carrying rollers 112, a pair of second carrying rollers 113, and a pair of third carrying rollers 114 are formed as the paper feeding unit. A carrying direction of the recording medium p is a sub-scan direction when it is viewed from a recording operation in the ink jet recording apparatus 1.

In the downstream side of the carrying direction of the recording medium p on the carrying belt 107, a heat-fixing device 120 which heats the image-formed recording medium p, the pair of the first carrying rollers 112, the pair of the second carrying rollers 113, and the pair of the third carrying rollers 114 are disposed. The heat-fixing device 120 will be described in detail later.

Above the carrying belt 107, ink jet heads which eject inks to the recording medium according to image data are disposed on four lines. Specifically, from the upstream side, an ink jet head 115C which ejects a cyan (C) ink, an ink jet head 115M which ejects a magenta (M) ink, an ink jet head 115Y which ejects a yellow (Y) ink, and an ink jet head 115Bk which ejects a black (Bk) ink are disposed in this order.

In the ink jet heads 115C, 115M, 115Y, and 115Bk, nozzles are disposed at a predetermined resolution along a width direction of the recording medium p, respectively. That is, the ink jet heads 115C, 115M, 115Y, and 115Bk are line type print heads in which plural nozzles are arranged on a line. In the ink jet heads 115C, 115M, 115Y, and 115Bk, the nozzles are arranged in a direction perpendicular to the carrying direction of the recording medium p by the carrying belt 107. The nozzles are arranged so as to be positioned with a defined distance with respect to the recording medium p which is located on the carrying belt 107. Here, an alignment direction of the nozzles is a main scan direction.

The ink jet recording apparatus 1 of the first embodiment is provided with the line type ink jet heads 115C, 115M, 115Y, and 115Bk on the carrying belt 107 which carries the recording medium p. The ink jet heads 115C, 115M, 115Y, and 115Bk perform the recording operation on the recording medium p on the basis of image signals inputted. If the ink jet heads 115C, 115M, 115Y, and 115Bk is a line type, any driving scheme thereof is sufficient. That is, in the ink jet heads 115C, 115M, 115Y, and 115Bk, a scheme using thermoelectric conversion elements, a scheme using electrostrictive conversion elements, or other schemes of ink ejecting scheme are applicable.

The carrying belt 107 and the driving roller 108 are sub-scan driving units which relatively move the recording medium p and the ink jet heads 115C, 115M, 115Y, and 115Bk in the sub-scan direction perpendicular to the alignment direction of the nozzles. That is, the carrying belt 107 and the driving roller 108 perform a sub-scan driving process in which the recording medium p and the ink jet heads 115C, 115M, 115Y, and 115Bk are relatively moved in the sub-scan direction perpendicular to the alignment direction of the nozzles.

That is, the ink jet recording apparatus 1 of the first embodiment performs the recording operation on the recording medium p in the line scheme (one path recording scheme). A control unit 300 controls the ink jet heads 115C, 115M, 115Y, and 115Bk to be driven on the basis of the image signals to perform a main scan driving process in which ink droplets are selectively ejected from the nozzles. In addition, the control unit 300 controls the driving roller 108 to be driven by a driving motor 301. The control unit 300 performs the sub-scan driving process in which the ink jet heads 115C, 115M, 115Y, and 115Bk and the recording medium p are relatively moved in the sub-scan direction. The recording operation is performed by the main scan driving process and the sub-scan driving process.

Further, in the ink jet heads 115C, 115M, 115Y, and 115Bk, a cyan (C) ink cartridge 116C, a magenta (M) ink cartridge 116M, a yellow (Y) ink cartridge 116Y, and a black (Bk) ink cartridge 116Bk in which respective colors are filled are provided. The ink jet head 115C and the ink cartridge 116C, the ink jet head 115M and the ink cartridge 116M, the ink jet head 115Y and the ink cartridge 116Y, and the ink jet head 115Bk and the ink cartridge 116Bk are connected through tubes 117, respectively.

Here, an example of composition in aqueous inks of black, yellow, cyan, and magenta will be shown.

Black1
Self-dispersed carbon black dispersion liquid
(Made by Cabot Specialty Chemicals Ink)

| | | |
|---|---|---|
| (Carbon black solid content concentration) | 8.0% | by weight |
| Glycerin | 30.0% | by weight |
| Ethylene glycol mono butyl ether | 0.5% | by weight |
| Surfynol 465 | 1.0% | by weight |
| Proxel XL-2 (S) | 0.2% | by weight |
| Ion-exchange water remaining amount | (60.3% | by weight) |

Black2
Self-dispersed carbon black dispersion liquid
(Made by Cabot Specialty Chemicals Ink)

| | | |
|---|---|---|
| (Carbon black solid content concentration) | 8.0% | by weight |
| Glycerin | 30.0% | by weight |
| Ethylene glycol | 10.0% | by weight |
| Diethylene glycol mono butyl ether | 5.0% | by weight |
| Surfynol 465 | 1.0% | by weight |
| Proxel XL-2 (S) | 0.2% | by weight |
| Ion-exchange water remaining amount | (45.8% | by weight) |

Yellow
Self-dispersion yellow dispersion liquid
(Made by Cabot Specialty Chemicals Ink)

| | | |
|---|---|---|
| (Yellow pigment solid content concentration) | 6.0% | by weight |
| Glycerin | 45.0% | by weight |
| Ethylene glycol mono butyl ether | 5.0% | by weight |
| Surfynol 465 | 1.0% | by weight |
| Proxel XL-2 (S) | 0.2% | by weight |
| Ion-exchange water remaining amount | (42.8% | by weight) |

Magenta
Polymer dispersant dispersed magenta dispersion liquid
(Made by Fuji coloring matter)

| | | |
|---|---|---|
| (Magenta pigment solid content concentration) | 6.0% | by weight |
| Glycerin | 45.0% | by weight |
| Diethylene glycol mono butyl ether | 5.0% | by weight |
| Surfynol 465 | 1.0% | by weight |
| Proxel XL-2 (S) | 0.2% | by weight |
| Ion-exchange water remaining amount | (42.8% | by weight) |

Cyan
Polymer dispersant dispersed cyan dispersion liquid
(Made by Fuji coloring matter)

| | | |
|---|---|---|
| (Cyan pigment solid content concentration) | 6.0% | by weight |
| Glycerin | 45.0% | by weight |
| Triethylene glycol mono butyl ether | 5.0% | by weight |
| Surfynol 465 | 1.0% | by weight |
| Proxel XL-2 (S) | 0.2% | by weight |
| Ion-exchange water remaining amount | (57.2% | by weight) |

The above-mentioned ink includes water of 60.3% by weight as a maximum value and at least 42.8% by weight as a minimum value. Until the image is completely formed, it is necessary to dry the recording medium by evaporating the moisture down to an amount of moisture which is generally absorbed into the recording medium.

Next, an image formation by the ink jet recording apparatus 1 of the first embodiment will be described.

Firstly, when the control unit 300 obtains image data to be printed on the recording medium p via an external interface 302, an image process begins. The control unit 300 transfers the image data subjected to the image process to the ink jet heads 115C, 115M, 115Y, and 115Bk. Here, the ink jet heads 115C, 115M, 115Y, and 115Bk are connected with respective colors of the ink cartridges 116C, 116M, 116Y, and 116Bk through the tubes 117, respectively. In the ink jet heads 115C, 115M, 115Y, and 115Bk, proper inks are supplied on the basis of the image data.

The first paper feeding roller 102 or the second paper feeding roller 103 withdraws the recording medium p corresponding to the selected size of the recording medium one by one from the first paper cassette 100 or the second paper cassette 101. The recording medium p is carried to the pair of the first carrying rollers 104 or the pair of the second carrying rollers 105 and the pair of the resist rollers 106.

The pair of the resist rollers 106 corrects a skew of the recording medium p and begins to carry the recording medium at a predetermined timing. By reducing pressure in the negative pressure chamber 111, air is drawn through holes of the carrying belt 107. The recording medium p which is absorbed on the carrying belt 107 is carried to a position facing the ink jet heads 115C, 115M, 115Y, and 115Bk. Therefore, a distance between the ink jet heads 115C, 115M, 115Y, and 115Bk and the recording medium p is maintained at a constant interval, for example, 0.5 to 2.0 mm. The control unit 300 is synchronized with the timing when the recording medium p is carried from the pair of the resist rollers 106, and ejects the respective colors from the ink jet heads 115C, 115M, 115Y, and 115Bk. Since the nozzles of the ink jet heads 115C, 115M, 115Y, and 115Bk are arranged along the width direction of the recording medium p, when the recording medium p is carried, a full color image is formed on the entire surface of the recording medium p.

After the Bk ink ejected from the ink jet head 115Bk is finally landed on the recording medium p and a predetermined time lapses, the carrying belt 107 carries the recording medium p to the heat-fixing device 120. The heat-fixing device 120 is a mechanism for evaporating the moisture which is included in the recording medium p in the middle of being passed. The recording medium p dried by the head-fixing device 120 is discharged to a discharge tray 118 by the pair of the first carrying rollers 112, the pair of the second carrying rollers 113, and the pair of the third carrying rollers 114.

Next, the heat-fixing device 120 which is provided on a downstream side of the ink jet recording apparatus 1 of the first embodiment will be described.

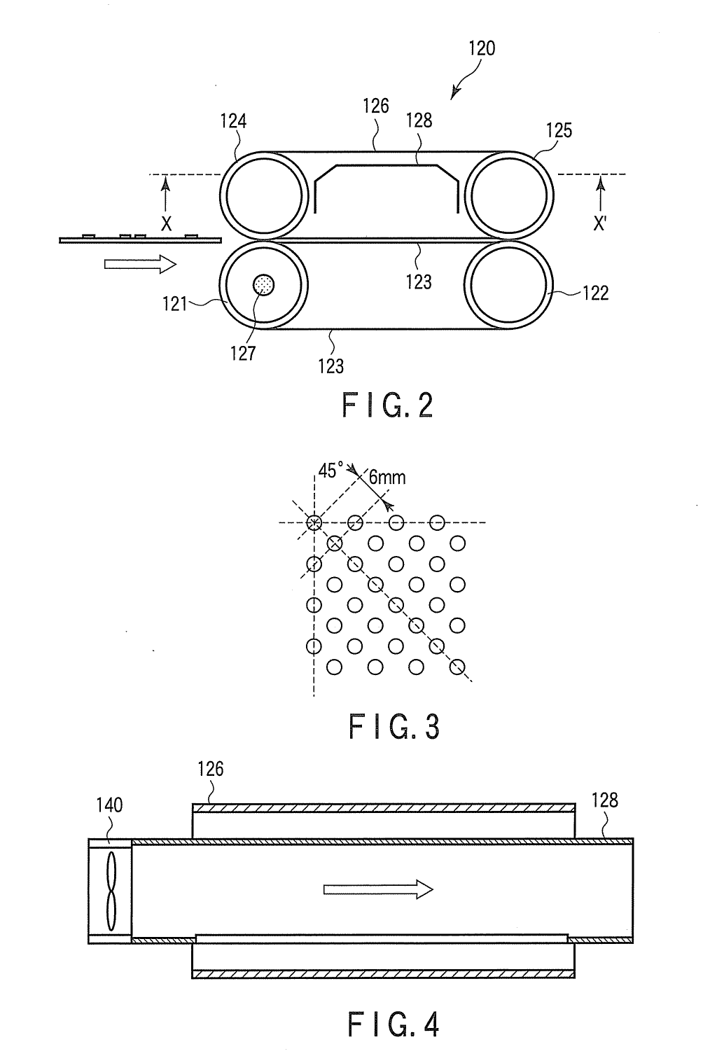

As shown in FIG. 2, in the heat-fixing device 120, a lower carrying belt 123 which is hung on rollers 121 and 122 and an upper carrying belt 126 which is hung on rollers 124 and 125 are disposed so as to be faced and to come into contact with each other. Here, the control unit 300 drives the roller 124 by using a driving motor 304. The upper carrying belt 126 is driven by a rotation of the roller 124. In addition, as the roller 124 hung on the upper carrying belt 126 is rotatably driven, the roller 121 is rotated and thus the lower carrying belt 123 is driven. Therefore, the lower carrying belt 123 and the upper carrying belt 126 carry the recording medium p at the same speed in the same direction. Here, the relation between driving and driven is only an example, even though the relation between driving and driven is changed or the rollers are separately operated, it may be applicable as long as the roller 121 and the roller 124 are rotated in synchronization with each other.

The lower carrying belt 123 and the upper carrying belt 126 include a metal conductive layer and a solid rubber layer from the inside thereof in this order. As a material of the metal conductive layer, for example, nickel (having a thickness of 40 to 100 μm) is used. In the metal conductive layer, stainless steel, aluminum, and a composite material of stainless steel and aluminum may be used. The solid rubber layer includes a silicon rubber having a thickness of 200 μm. As shown in FIG. 3, in the upper carrying belt 126, plural holes 400 having a diameter of Φ 2 mm are made at a predetermined interval. The holes 400 are provided, for example, at 6 mm interval so as to be inclined with 45 degree with respect to the sub-scan direction. A surface of the image-formed recording medium p comes into contact with the upper carrying belt 126 on which the holes 400 are provided.

A guide 128 is provided in the inside of the upper carrying belt 126, through which vapor generated by heating the image-formed recording medium p is diffused to the outside of the heat-fixing device 120. In the inside of the roller 121 which is hung on the upstream side of the lower carrying belt 126, a halogen lamp 127 is disposed. A surface temperature of the lower carrying belt 123 is maintained in a range of 50 to 250° C., preferably 100 to 200° C. via the roller 121. In this state, when the lower carrying belt 123 and the upper carrying belt 126 are rotated, heat is transferred from the lower carrying belt 123 to the upper carrying belt 126, and the upper carrying belt 126 is also heated.

An IH heater may be used in the internal of the roller 121 instead of the halogen lamp 127. Further, it may be possible that the roller 121 is made of a metal material, for example, iron or the like, and an IH coil may be provided therein. In this case, the heat occurs from the roller 121 by an eddy-current which is generated by the IH coil. Since the heat occurs in the roller 121 itself, the roller 121 has excellent thermal conductivity with respect to the recording medium p. In addition, the IH coil can rise rapidly in temperature.

When the lower carrying roller 123 is heated up to a predetermined temperature, the control unit 300 allows the ink jet heads 115C, 115M, 115Y, and 115Bk to perform the recording operation. When the lower carrying belt 123 and the upper carrying belt 126 carry the recording medium p, on which the image is formed, interposed therebetween, the heat is transferred on the recording medium p from the both of the lower carrying belt 123 and the upper carrying belt 126. The vapor is generated from the recording medium p. The generated vapor flows into the inside of the upper carrying belt 126 through the plural holes of the upper carrying belt 126.

The vapor flowing into the inside of the upper carrying belt 126 is diffused to the outside of the heat-fixing device 120 along the guide 128. The recording medium p which is passed through the heat-fixing device 120 is kept in tight contact with between the lower carrying belt 123 and the upper carrying belt 126. So, the recording medium p is good in the thermal conductivity and its temperature rises rapidly. In addition, since the recording medium p is heated by being interposed between the lower carrying belt 123 and the upper carrying belt 126, the recording medium p is carried from the heat-fixing device 120 to the pair of the first carrying rollers 112 or later without cockle or deformation.

FIG. 4 is a cross-sectional view taken on a line X-X′ in a height direction of the guide 128 which is provided in the inside of the upper carrying belt 126. The guide 128 is made of a stainless or a heat resistant resin. A lower side of the guide 128 where the recording medium p is faced is opened. Therefore, the vapor generated from the recording medium p flows from the opening to the inside of the guide 128.

A fan 140 which is provided on the upstream side (left side in the drawing) blows air along a direction of arrow in the drawing. The fan 140 diffuses the generated vapor from the downstream side. The control unit 300 drives the fan 140 via a driving motor 303 such that it blows air before the recording medium p passes through the heat-fixing device 120, and then the fan 140 also blows air for a predetermined time after the recording medium p passed there. It is because the vapor in the guide 128 is completely diffused.

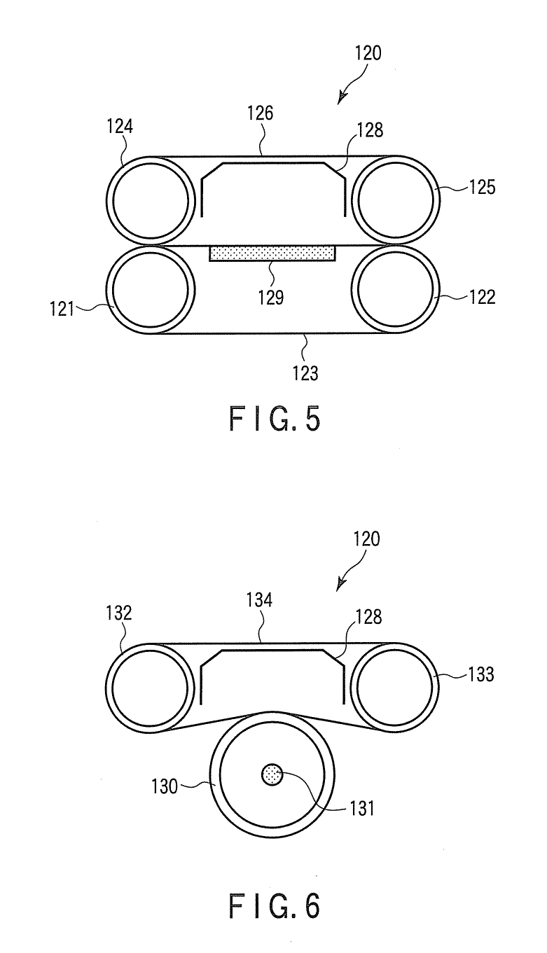

FIG. 5 is a modified example of the heat-fixing device 120 of the first embodiment. Alignments of the rollers 121 and 122 and the lower carrying belt 123, the rollers 124 and 125 and the upper carrying belt 126, and the guide 128 are similar to that of the configuration shown in FIG. 2. Here, instead of the halogen lamp 127 shown in FIG. 2, a heater 129 such as a ceramic heater is provided on an opposite side to a surface where the lower carrying belt 123 comes into contact with the recording medium p.

The heat generated from the heater 129 is propagated to the recording medium p via the lower carrying belt 123. The moisture contained in the recording medium p is heated to be vapor. As described in FIG. 2, the generated vapor is diffused to the outside of the heat-fixing device 120 through the plural holes 400 and the guide 128 which are provided at the upper carrying belt 126. The same effects are obtained from the heat-fixing device 120 shown in FIG. 5 as that of the heat-fixing device 120 shown in FIG. 2.

FIG. 6 is another modified example of the heat-fixing device 120 of the first embodiment. An upper carrying belt 134 which is hung on rollers 132 and 133 is disposed so as to come into contact with a heat roller 130. The recording medium p is carried by being interposed between the upper carrying belt 134 and the heat roller 130. In the inside of the heat roller 130, a halogen lamp 131 is provided. A surface temperature of the heat roller 130 is maintained in a range of 50 to 250° C., preferably 100 to 200° C.

Here, the control unit 300 drives the roller 132 by using a driving motor 305. The upper carrying belt 134 is driven by the rotation of the roller 132. In addition, as the roller 132 hung on the upper carrying belt 134 is rotatably driven, the heat roller 130 is rotatably driven. Therefore, the upper carrying belt 134 and the heat roller 130 carry the recording medium p at the same speed in the same direction. Here, the relation between driving and driven is only an example, even though the relation between driving and driven is changed or the rollers are separately operated, it may be applicable as long as the upper carrying belt 134 and the heat roller 130 are rotated in synchronization with each other.

The heat roller 130 comes into direct contact with the recording medium p. The heat roller 130 propagates the heat to the recording medium p on which the image is formed. The moisture contained in the recording medium p is heated to be vapor. As described in FIG. 2, the generated vapor is diffused to the outside of the heat-fixing device 120 through the holes of the upper carrying belt 134 and the guide 128. The same effects are obtained from the heat-fixing device 120 shown in FIG. 6 as that of the heat-fixing device 120 shown in FIG. 2.

According to the first embodiment described above, the recording medium p on which the image is formed by aqueous ink and contains the moisture is heated by being interposed between the lower carrying belt 123 and the upper carrying belt 126, or between the upper carrying belt 134 and the heat roller 130. For this reason, the recording medium p is efficiently heated.

Since the halogen lamp 127 is provided at the lower carrying belt 123, the recording medium p is mainly heated from the rear surface on which the image is not formed. The moisture contained in the image-formed recording medium p is unevenly distributed on the surface on which the image is formed. For this reason, the vapor which is generated from the recording medium p does not pass through the inside of the recording medium p, but being diffused to the outside of the recording medium p. Therefore, the recording medium p is not swollen by the vapor.

In addition, in the upper carrying belt 126 or the upper carrying belt 134 as a path for diffusing the vapor, which is generated from the recording medium p, plural holes 400 are provided. The vapor which is generated from the recording medium p is rapidly evaporated from the recording medium p. For this reason, the recording medium p is sufficiently dried by the configuration of the first embodiment. The vapor flows into the heat-fixing device 120 through the plural holes 400 which are provided in the upper carrying belt 126, is diffused to the outside of the heat-fixing device 120 along the guide 128 which is provided on the inside of the upper carrying belt 126 or the upper carrying belt 134. The vapor does not remain in the heat-fixing device 120. Therefore, the vapor is not condensed on a portion in which the temperature is low in the heat-fixing device 120, or parts made of metal does not become rusty.

As described above, according to the first embodiment, even though the plain paper is printed by using the aqueous ink, the cockling is not generated, so that a high quality of image can be formed on the recording medium p.

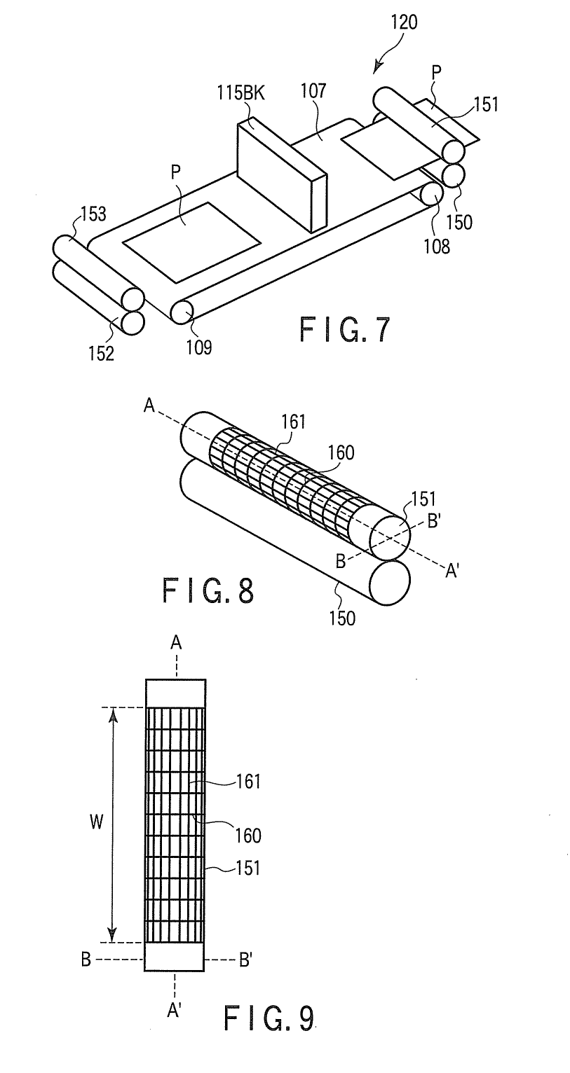

Next, a second embodiment will be described. FIG. 7 is a top perspective view schematically illustrating an appearance of the ink jet recording apparatus 1 of the second embodiment.

The ink jet recording apparatus 1 of the second embodiment is different in configuration of the heat-fixing device 120 of the ink jet recording apparatus 1 of the first embodiment shown in FIG. 1. As shown in FIG. 7, in the ink jet recording apparatus 1 of the second embodiment, the heat-fixing device 120 is provided with a heat roller 150 and a pressure roller 151.

The configuration up to a portion where the recording medium p is carried to the heat-fixing device 120 is similar to that of the first embodiment described above. After the recording operation of the ink jet heads 115C, 115M, 115Y, and 115Bk on the recording medium p, the carrying belt 107 carries the recording medium p to the heat-fixing device 120.

The pressure roller 151 is disposed above the heat roller 150 on the same axis along the height direction of the ink jet recording apparatus 1. The heat roller 150 is a thermal source which includes the halogen lamp or the IH heater therein. Further, it may be possible that the heat roller 150 is made of a metal material and an IH coil is provided in the internal thereof.

The pressure roller 151 is disposed so as to come into pressing contact with the heat roller 150. The pressure roller 151 presses and carries the recording medium p to the heat roller 150. Here, the control unit 300 drives the heat roller 150 by using a driving motor 306. As the heat roller 150 is rotated, the pressure roller 151 is rotatably driven. Therefore, the heat roller 150 and the pressure roller 151 carry the recording medium p at the same speed in the same direction. Here, the relation between driving and driven is only an example, even though the relation between driving and driven is changed or the rollers are separately operated, it may be applicable as long as the heat roller 150 and the pressure roller 151 are rotated in synchronization with each other. Using the heat roller 150 formed as a heating unit and the pressure roller 151 formed as a pressing unit, the heat-fixing device 120 is a heat-fixing unit which heats the image-formed recording medium p.

In addition, as shown in FIG. 7, a pair of a heat roller 152 and a pressure roller 153 may be provided on the upstream side of the ink jet heads 115C, 115M, 115Y, and 115Bk along the carrying direction of the recording medium p. The heat roller 152 and the pressure roller 153 preheat the recording medium p before the ink jet heads 115C, 115M, 115Y, and 115Bk begin to perform the recording operation on the recording medium p. Since the ink jet heads 115C, 115M, 115Y, and 115Bk perform the recording operation on the preheated recording medium p, the moisture is evaporated from the recording medium p even though before the recording medium p is carried to the heat roller 150 and the pressure roller 151. Also in the first embodiment shown in FIG. 1, the pair of the heat roller 152 and the pressure roller 153 can be provided.

FIG. 8 is a top perspective view illustrating a configuration of the heat-fixing device 120 of the second embodiment. In addition, FIG. 9 is a plan view illustrating a surface taken on lines A-A′ and B-B′ of the pressure roller 151 shown in FIG. 8 when it is viewed from the heat roller 150.

On the surface of the pressure roller 151, plural first wire members 160 which are disposed so as to be extended in a direction along the sub-scan direction, and plural second wire members 161 which are disposed so as to be extended in the main scan direction cross to the first wire members 160 are provided. On the surface of the pressure roller 151, a number of mesh convex portions are formed by the plural first wire members 160 and the plural second wire members 161. The plural first wire members 160 and the plural second wire members 161 may be formed so as to be perpendicular to each other or to be provided so as to be crossed with different inclinations.

The convex portions provided on the surface of the pressure roller 151 press the recording medium p to the heat roller 150 so as to come into contact therewith. Therefore, the convex portions provided on the surface of the pressure roller 151 efficiently propagate the heat to the recording medium p by heating of the heat roller 150. In addition, a width W of the main scan direction which is a range of the convex portions provided on the surface of the pressure roller 151 is wider than that of the recording medium p. For this reason, the pressure roller 151 presses the recording medium p over the entire surface thereof.

In portions except for the convex portions which are formed by the plural first wire members 160 and the plural second wire members 161 which are provided on the surface of the pressure roller 151, concave portions are formed. When the pressure roller 151 presses the recording medium p, the concave portions provided on the surface of the pressure roller 151 serve as gaps between the recording medium p and the pressure roller 151 to diffuse the moisture in ink which is contained in the recording medium p heated by the heat roller 150 to the atmosphere. Therefore, the moisture in ink which is contained in the recording medium p heated by the heat roller 150 does not remain in the recording medium p, but is efficiently diffused as the vapor to the atmosphere through the concave portions of the surface of the pressure roller 151.

Here, if area of the convex portions provided on the surface of the pressure roller 151 becomes larger, an effect that the ink contained in the recording medium p is accelerated to be heat-fixed is increased according to the area pressing the recording medium p to the heat roller 150. On the other hand, if the area of the concave portions provided on the surface of the pressure roller 151 becomes smaller, the effect that the moisture in ink which is contained in the recording medium p is diffused to the atmosphere to be vapor is decreased.

If the area of the convex portions provided on the surface of the pressure roller 151 becomes smaller, the area of the concave portions provided on the surface of the pressure roller 151 becomes larger, so that the effect that the moisture in ink which is contained in the recording medium p is diffused to the atmosphere to be vapor is increased. On the other hand, if the area of the convex portions provided on the surface of the pressure roller 151 becomes smaller, the effect that the ink contained in the recording medium p is accelerated to be heat-fixed is decreased. As a result, the ink contained in the recording medium p remains to be unfixed.

In the heat-fixing device 120 of the second embodiment, the mesh convex portions are disposed at a moderate interval on the surface of the pressure roller 151. Therefore, while accelerating the heat-fixing of the ink with respect to the recording medium p, the moisture in ink which is contained in the recording medium p can be diffused to the atmosphere to be vapor. Further, it is possible to substantially prevent the bending of the recording medium p.

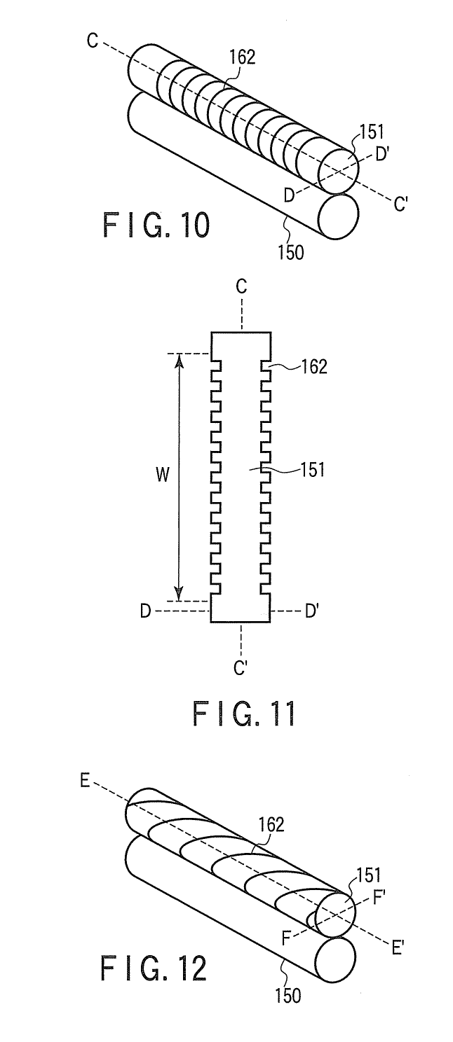

FIG. 10 is a modified example of the heat-fixing device 120 of the second embodiment. FIG. 10 is a top perspective view illustrating a configuration example of the heat-fixing device 120. In addition, FIG. 11 is a plan view illustrating a surface taken on lines C-C′ and D-D′ of the pressure roller 151 shown in FIG. 10 when it is viewed from the heat roller 150.

On the surface of the pressure roller 151, at least one or more grooves 162 are provided so as to be extended in a direction along the sub-scan direction. On the surface of the pressure roller 151 with the grooves 162, a number of concave portions and convex portions are formed.

The convex portions provided on the surface of the pressure roller 151 press the recording medium p to the heat roller 150 so as to come into contact therewith. Therefore, the convex portions provided on the surface of the pressure roller 151 efficiently propagate the heat to the recording medium p by heating of the heat roller 150. In addition, the width W of the main scan direction which is the range of the convex portions provided on the surface of the pressure roller 151 is wider than that of the recording medium p. For this reason, the pressure roller 151 presses the recording medium p over the entire surface thereof.

When the pressure roller 151 presses the recording medium p, the grooves 162 provided on the surface of the pressure roller 151 serve as gaps between the recording medium p and the pressure roller 151 to diffuse the moisture in ink which is contained in the recording medium p heated by the heat roller 150 to the atmosphere. Therefore, the moisture in ink which is contained in the recording medium p heated by the heat roller 150 does not remain in the recording medium p, but is efficiently diffused as the vapor to the atmosphere through the grooves 162 of the surface of the pressure roller 151.

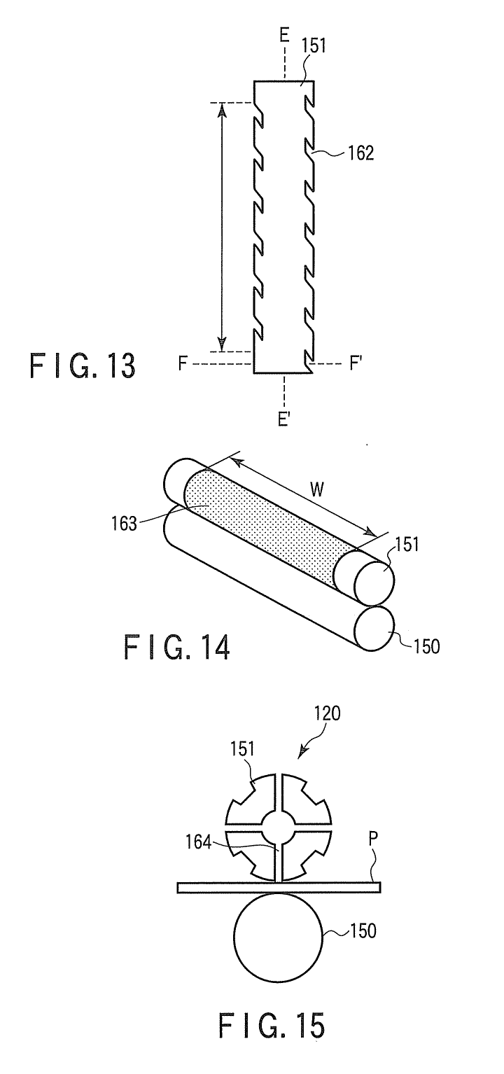

FIG. 12 is another modified example of the heat-fixing device 120 of the second embodiment. FIG. 12 is a top perspective view illustrating a configuration example of the heat-fixing device 120. In addition, FIG. 13 is a plan view illustrating a surface taken on lines E-E′ and F-F′ of the pressure roller 151 shown in FIG. 12 when it is viewed from the heat roller 150. On the surface of the pressure roller 151, spiral grooves 162 are provided along the main scan direction.

As described above, the convex portions provided on the surface of the pressure roller 151 press the recording medium p to the heat roller 150 so as to come into contact therewith, so that the moisture in ink which is contained in the recording medium p is efficiently diffused to the atmosphere to be vapor through the grooves 162 provided on the surface of the pressure roller 151.

FIG. 14 is another modified example of the heat-fixing device 120 of the second embodiment. FIG. 14 is a top perspective view illustrating a configuration example of the heat-fixing device 120. On the surface of the pressure roller 151, a sponge-shaped porous material 163 is formed. The porous material 163 is provided with a number of minute spaces on its surface. In addition, a width W of the main scan direction which is a range of the porous material 163 provided on the surface of the pressure roller 151 is wider than that of the recording medium p. For this reason, the pressure roller 151 presses the recording medium p over the entire surface thereof.

When the pressure roller 151 presses the recording medium p, the minute spaces of the porous material 163 provided on the surface of the pressure roller 151 serve as gaps between the recording medium p and the pressure roller 151 to diffuse the moisture in ink which is contained in the recording medium p heated by the heat roller 150 to the atmosphere. Therefore, the moisture in ink which is contained in the recording medium p heated by the heat roller 150 does not remain in the recording medium p, but is efficiently diffused as the vapor to the atmosphere.

In the second embodiment described above, there are provided with a number of the concave portions and the convex portions on the surface of the pressure roller 151. On the other hand, as shown in FIG. 15, it also may be possible that the moisture in ink which is contained in the recording medium p may be diffused to the atmosphere through the convex portions of the pressure roller 151 which faces and presses the recording medium p. FIG. 15 is a cross-sectional view illustrating the heat-fixing device 120 viewed from a horizontal direction. Through holes 164 are provided from a space in the pressure roller 151 to a surface of the convex portions of the pressure roller 151. The moisture in ink which is contained in the recording medium p heated by the heat roller 150 is diffused through not only the concave portions of the pressure roller 151 but also the through holes 164 which is provided in the convex portions of the pressure roller 151 which is a contact surface with the recording medium p. In the inside of the pressure roller 151, it may be effective that an absorbing device is used for efficiently absorbing the vapor through the through holes 164.

What is claimed is:

1. An ink jet recording apparatus comprising:
an ink jet head on which a plurality of nozzles are arranged;
a sub-scan driving unit which carries a recording medium to be formed with an image;
a first carrying unit which is disposed on a downstream side of a carrying direction of the recording medium by the sub-scan driving unit and carries the recording medium where an image is formed by the ink jet head; and
a second carrying unit which is disposed so as to face the first carrying unit and heats the recording medium interposed with the first carrying unit.

2. The apparatus of claim 1, wherein the first carrying unit includes a belt having a plurality of holes.

3. The apparatus of claim 2, wherein the first carrying unit is disposed above the second carrying unit.

4. The apparatus of claim 3, comprising a guide which diffuses vapor generated from the image-formed recording medium is included in the first carrying unit.

5. The apparatus of claim 4, comprising a fan which ventilates to the outside along the guide.

6. The apparatus of claim 1, wherein the second carrying unit carries the recording medium at the same speed at that of the first carrying unit.

7. The apparatus of claim 1, wherein the second carrying unit heats the recording medium from an opposite surface with respect to an image forming surface thereof.

8. The apparatus of claim 1, further comprising a heating unit which is disposed on an upstream side of the ink jet head in the carrying direction of the recording medium and preheats the recording medium.

9. The apparatus of claim 1, wherein the second carrying unit carries the recording medium at the same speed as that of the first carrying unit.

10. An ink jet recording apparatus comprising:
an ink jet head on which a plurality of nozzles are arranged;
a sub-scan driving unit which carries a recording medium to be formed with an image;
a first roller which is disposed on a downstream side of a carrying direction of the recording medium by the sub-scan driving unit and carries the recording medium where an image is formed by the ink jet head; and
a second roller which is disposed so as to face the first roller and heats the recording medium.

11. The apparatus of claim 10, wherein the first roller carries the recording medium at the same speed as that of the second roller.

12. The apparatus of claim 10, further comprising a heating unit which is disposed on an upstream side of the ink jet head in the carrying direction of the recording medium and preheats the recording medium.

13. The apparatus of claim 10, wherein the second roller includes a plurality of first wire members which are disposed so as to be extended in a direction along the sub-scan direction, and a plurality of second wire members which are disposed so as to be extended in a direction perpendicular to the first wire members.

14. The apparatus of claim 10, wherein the second roller includes at least one groove in a direction along the sub-scan direction.

15. The apparatus of claim 10, wherein the second roller includes a porous material on its surface.

16. The apparatus of claim 10, wherein the second roller has a width larger than that of the recording medium.

17. A drying method of an ink jet recording apparatus which includes an ink jet head on which a plurality of nozzles are arranged, a sub-scan driving unit which carries a recording medium to be formed with an image, and a heat-fixing unit which is disposed on a downstream side of a carrying direction of the recording medium by the sub-scan driving unit and heats the recording medium where an image is formed by the ink jet head, the method comprising:
carrying the recording medium while both surfaces of an image forming surface and an opposite surface to the image forming surface of the recording medium are interposed; and
heating the recording medium from the opposite surface of the image forming surface.

18. The method of claim 17, further comprising carrying the image forming surface so as to come into contact with a belt where a plurality of holes are provided.

19. The method of claim 17, further comprising carrying the image forming surface so as to come into contact with a roller where a plurality of grooves are provided.

20. The method of claim 17, further comprising preheating the recording medium on an upstream side of the ink jet head in a carrying direction of the recording medium.
